(19) United States
(12) Patent Application Publication
(10) Pub. No.: US 2025/0187975 A1
(43) Pub. Date: Jun. 12, 2025

(54) METHOD FOR ERASING A LASER-INDUCED MARKING OF GLASS SHEETS AS WELL AS METHOD AND DEVICES FOR MARKING AND UNMARKING GLASS SHEETS, PREFERABLY BASIC GLASS SHEETS, PREFERABLY FLOAT GLASS SHEETS

(71) Applicant: HEGLA boraident GmbH & Co. KG, Beverungen (DE)

(72) Inventor: Thomas Rainer, Wernigerode (DE)

(21) Appl. No.: 18/039,571

(22) PCT Filed: Nov. 3, 2021
(86) PCT No.: PCT/EP2021/080482

§ 371 Date: Nov. 14, 2023

(30) Foreign Application Priority Data
Dec. 2, 2020 (DE) 10 2020 215 234.9

(51) Int. Cl. C03C 23/00

(52) U.S. Cl. CPC C03C 23/0025

(57) ABSTRACT

A method and apparatuses for marking and de-marking glass plates, preferably basic glass plates, more preferably float glass plates including laser-induced generation of a marking in the glass plate or on the surface of the glass plate and de-marking by means of laser radiation. A method for erasing a laser-induced marking of glass plates, preferably of basic glass plates, more preferably of float glass plates is also provided using laser radiation.

### CROSS REFERENCE TO RELATED APPLICATIONS

This application is a 35 U.S.C. § 371 national phase application of International Application No.: PCT/EP2021/080482, filed Nov. 3, 2021, which claims the benefit of priority under 35 U.S.C. § 119 to German Patent Application No.: 10 2020 215 234.9, filed Dec. 2, 2020, the contents of which are incorporated herein by reference in their entirety.

### FIELD

The present invention relates to a method and devices for marking and unmarking glass sheets, preferably basic glass sheets, preferably float glass sheets. The invention also relates to a method for erasing a laser-induced marking from glass sheets, preferably from basic glass sheets, preferably from float glass sheets, and a use therefor according to the invention.

### BACKGROUND

The statements in this section merely provide background information related to the present disclosure and several definitions for terms used in the present disclosure and may not constitute prior art.

Basic glass sheets are the starting material or raw material for the production of functional glass or flat glass products, e.g. single-pane safety glass sheets or laminated safety glass sheets or insulating glazing. In addition, basic glass sheets are flat glass. Flat glass is any glass in the form of glass sheets, regardless of the manufacturing process, dimension and shape and finishing applied. Basic glass sheets are therefore glass raw sheets.

The basic glass sheets are also usually made of silicate glass.

Float glass sheets are flat glass produced by the float process or float glass process. The float glass process is an endless continuous manufacturing process in which a liquid glass melt is continuously fed from one side onto a bath of liquid tin. The glass mass “floats” on the molten tin in the form of an endless, distortion-free float glass ribbon. At the end of the float pan, the float glass ribbon enters into a cooling channel where it is slowly cooled to room temperature. The glass ribbon is cut into glass raw sheets, e.g. of size 600×321 cm, and then transported to the glass processor, which produces, for example, insulating glass sheets, single-pane safety glass sheets or laminated safety glass sheets therefrom.

The float glass process has been used industrially since the 1960s and has since largely displaced most other methods of flat glass production or the manufacture of glass raw sheets.

Other types of basic glass include ornamental glass or Fourcault glass.

Ornamental glass (also called cast glass or structural glass) is produced by engraving a pattern into the still glowing glass mass by means of two rollers. The textured rollers produce glass with a more or less heavily ornamented surface on one or both sides.

The Fourcault glass process is a method of producing transparent window glass by the drawing process, in which the glass melt swells over a rectangular drawing nozzle set into it and is immediately afterwards gripped laterally by catch bars and drawn vertically upwards. Pairs of rollers convey the solidifying glass mass through a vertical cooling shaft.

It is known in the art to provide the manufactured basic glass sheets, in particular the float glass sheets, with a marking containing specific information regarding the basic glass sheet. e.g., the marking contains information about the quality of the basic glass sheet, e.g., whether the basic glass sheet comprises glass defects and, if so, at which location. Glass defects may be, for example, bubbles and/or particle inclusions, e.g., metallic inclusions, or streaks or cracks. This information is stored in a database and read out by the glass processor, enabling him to utilize the basic glass sheet accordingly, e.g. to place cuts in such a way that the glass defects are cut out.

This is because the basic glass sheets produced, especially the float glass sheets, usually have to be cut to size for their subsequent use. For this purpose, in particular glass raw sheets are cut into individual glass sheet blanks. This is done in cutting units known per se, either still at the basic glass manufacturer or at a downstream glass processor. After cutting, the glass sheet blanks or the cut glass sheets are preferably further processed in a further processing unit, for example an insulating glass line, a processing unit, e.g. a unit for edge processing, or a tempering device.

Still at the basic glass manufacturer or also at a downstream glass processor, the single-pane basic glass sheets produced can also be processed into laminated basic glass sheets by joining two or more single-pane basic glass sheets together. If desired, the single-pane basic glass sheets can be provided with a functional layer beforehand.

The markings are present, for example, as a string of characters or in the form of codes, in particular machine-readable codes, e.g. data matrix codes (DCM).

There is a need for labeling not only during production, but also during processing of the glass sheets. On the one hand, labeling facilitates the organization of the production cycle and, on the other hand, enables product tracking. There is a constant change of content of the labeling. In addition, the marking of the basic glass should not appear on the end product. This results in the desire for erasable markings.

In the technical field, for example, marking is currently carried out according to the principle of ink-jet printing (applying marking method), wherein the first marking is made at the cold end of the manufactured float glass ribbon before cutting into float glass sheets. The marking is removed again before each further processing step during processing and then reapplied. This is also done to avoid a quality-impairing influence by the ink of the marking during the following processing steps. For example, the ink is disturbing during the application of functional layers and the production of laminated basic glass sheets.

EP 1 735 517 B1 discloses a glazing comprising at least one permanent marking visible from the outside, identifiable by anyone, consisting of a string of characters. The marking represents information relating to technical characteristics of the glazing, its manufacture or commercial information. The character string comprises a sequence of numbers, each number being encoded by binary or hexadecimal coding according to one or more consecutive characters of the labeling element. The marking may be done by engraving or imprinting.

Furthermore, laser marking processes for marking glass sheets are known from the two publications DE 10 2005 026 038 A1 and DE 10 2005 025 982 A1:

According to DE 10 2005 026 038 A1, a glass-like layer with metal nanoparticles is applied to the surface of the glass sheet by means of a laser. For this purpose, a dispenser or carrier medium is brought into contact with the glass sheet surface to be labeled and a marking is produced on the glass sheet surface by laser beam-induced processes. The carrier medium comprises, for example, a PET film which comprises, for example, a low-E functional coating, wherein this comprises at least one metallic functional layer. For marking, a laser beam is directed onto the functional coating and, due to the laser beam irradiation, material from the functional coating is transferred from the PET carrier film to the glass sheet surface to be marked. The material adheres to the glass sheet surface as a glass-like matrix with metallic nanoparticles, wherein the matrix is formed from the substances originally present in the functional layers of the functional coating. The PET carrier film remains intact.

According to DE 10 2005 025 982 A1, laser radiation is used in a similar way to change the color of the low-E functional coating of a glass sheet so that a marking is produced.

In addition, it is known in the field to provide the glass sheets with an internal marking, which is located inside the glass sheets. The internal marking can be carried out laser-induced, for example (Forschungsvereinigung Feinmechanik, Optik und Medizintechnik e.V., “Untersuchung zur Materialreaktion im Innern optisch transparenter Materialien nach Ultrakurz-Laserpulsanregung: Generierung spannungsarmer Innenmarkierungen (micro-dots)).

For example, it is known to generate laser-induced microcracks in glass. The structures created scatter the light and are thus recognizable as markings and can be read with code readers. However, the microcracks change the mechanical properties of the glass sheets.

In addition, laser-induced generation of color centers (volume coloring) in the glass for internal marking is known. The internal marking of glass sheets due to the formation of color centers is based on the fact that defects are created in the SiO₂ network by the laser radiation. The defects lead to a change in the optical properties, in particular to a decrease in optical transmission. A color center is thus a defect in the SiO₂ network that absorbs visible light. Electromagnetic radiation in the wavelength range of visible light can be absorbed in a color center, resulting in a yellowish brown discoloration of the glass. Lasers with a pulse duration in the picosecond and femtosecond range with wavelengths from 355 to 1064 nm are used to generate color centers (volume coloring). Internal marking by means of color centers is thermally reversible.

In addition, internal marking can be done by generating micro-dots, which is based on the local change of the complex refractive index (=optical density). The density change is generated by local melting of the material, i.e. a thermal process. Lasers with a pulse duration in the picosecond and femtosecond range with wavelengths from 355 to 1064 nm are also used to generate micro-dots. Internal marking using micro-dots is thermally stable. However, it also changes the mechanical strength of the glass, since stresses are generated around the local density change.

DE 101 62 111 A1, for example, discloses a process for the internal marking of glass, for example, in which a laser beam for which the glass is transparent is directed onto a surface of the glass. For example, a laser with a pulse duration of 200 fs and a wavelength of 800 nm is used. The laser beam is focused at a location that is a distance from the surface and is located within the glass so that a high power density is present there. The high power density of the laser beam achieved in this way induces non-linear optical effects of excitation, so that a very localized energy effect occurs in the transparent material. Depending on the component and the power density of the laser beam, changes in the complex refractive index can thus be achieved, causing the creation of a marking within the transparent material in the form of an area of altered optical properties. These altered optical properties of the marking created by the process of the invention are intended to be limited to changes in the complex refractive index. Micro-cracks in the component shall not occur if the process is suitably adjusted. The internal marking is permanently maintained in a temperature range up to several 100 K above room temperature.

One objective of the present disclosure is to provide a method for erasing a laser-induced marking of glass sheets, preferably of basic glass sheets, more preferably of float glass sheets, which is economical and does not lead to any mechanical impairment of the glass sheets.

A further objective of the present disclosure is to provide a method for marking and unmarking of glass sheets, preferably of basic glass sheets, preferably of float glass sheets, which is economical and does not lead to any mechanical impairment to the glass sheets and allows machine-readable labeling.

Another objective is to provide devices for carrying out the method.

### SUMMARY

These objectives of the present disclosure are solved by a method for erasing a laser-induced marking from glass sheets, preferably from basic glass sheets, preferably from float glass sheets, characterized in that the marking is erased by means of laser radiation. The objects are further solved by a method for marking and unmarking glass sheets, preferably basic glass sheets, especially float glass sheets that comprises the process steps of laser-induced generation of a marking in the glass sheet or on a surface of the glass sheet, and erasing the marking by means of laser radiation.

The objectives of the present disclosure are also solved by a device for marking and unmarking glass sheets, preferably basic glass sheets, especially float glass sheets, by carrying out the method as previously described above and as further defined herein. This device comprises a marking device and an unmarking device. The marking device comprises a laser head for providing ultrashort pulsed laser radiation for laser-induced generation of an internal marking in the glass sheet by formation of color centers, or of a surface marking by means of laser engraving, preferably with a penetration depth <10 μm. The unmarking device comprises a laser head for erasing the internal marking by means of laser radiation which preferably lies in a wavelength range which is absorbed by the color centers and/or which preferably has a wavelength which lies in the complementary color range to the color of the internal marking, or for erasing the surface marking by means of laser polishing, preferably with laser radiation which lies in a wavelength range that is absorbed by the surface of the glass sheet.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a highly simplified schematic of a section through a glass sheet to be marked with a marking device according to one embodiment of the present disclosure;

FIG. 2 is a highly simplified schematic of a section through a marked glass sheet with a unmarking device according to another embodiment of the present disclosure;

FIG. 3 is a highly simplified schematic showing a top view of an endless float glass ribbon;

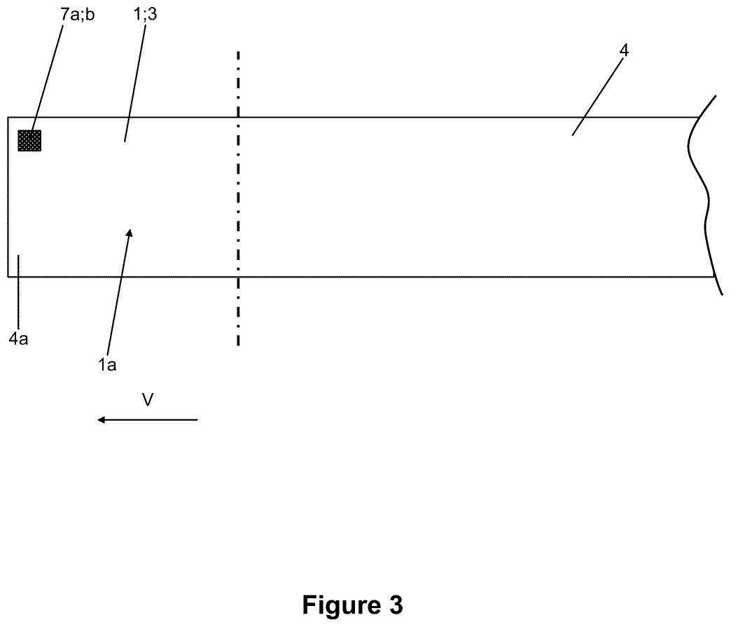

FIG. 4 is an absorption spectra of the initial glass, the marked glass, and the unmarked glass according to the teachings of the present disclosure,

FIG. 5 is a highly simplified schematic of a section through a glass sheet to be marked with a marking device according to a further embodiment of the present disclosure; and

FIG. 6 is a highly simplified schematic a section through a marked glass sheet with a unmarking device according to a further embodiment of the present disclosure.

The drawings are provided herewith for purely illustrative purposes and are not intended to limit the scope of the present invention.

### DETAILED DESCRIPTION

The following description is merely exemplary in nature and is in no way intended to limit the present disclosure or its application or uses. It should be understood that throughout the description, corresponding reference numerals indicate like or corresponding parts and features.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Within the scope of the invention, it was surprisingly found out that it is possible to first create a laser-induced internal marking by means of volume coloring in the glass sheets and then to erase or remove the created internal marking again, also by means of laser radiation.

Laser-induced means generated by means of laser radiation.

Alternatively, the marking can also be done by laser-induced, superficial ultra-fine engraving. Within the scope of the invention, it has now been found out that this marking can also be removed or erased again by means of laser polishing.

In the context of the present disclosure, erasing includes not only complete removal of the marking, even though this is preferred, but also weakening to such an extent that the information in the marking can no longer be read.

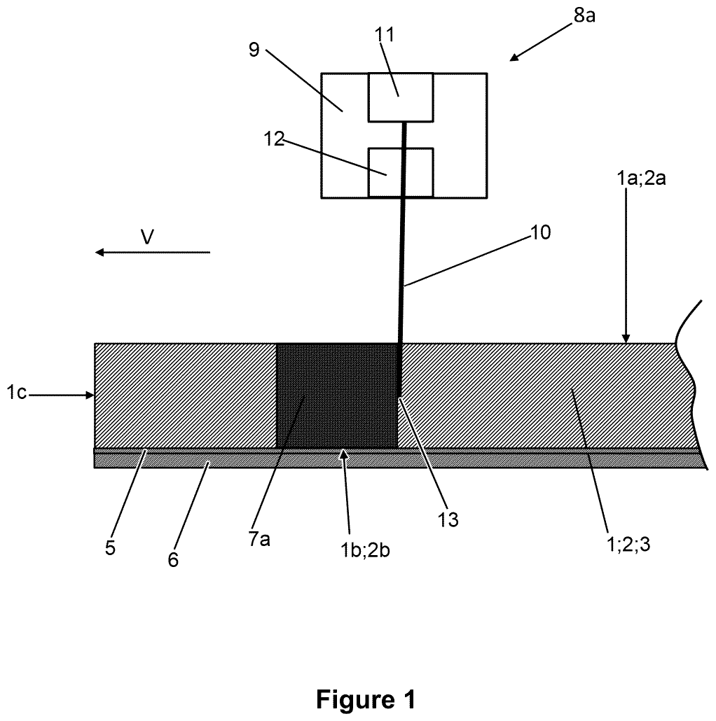

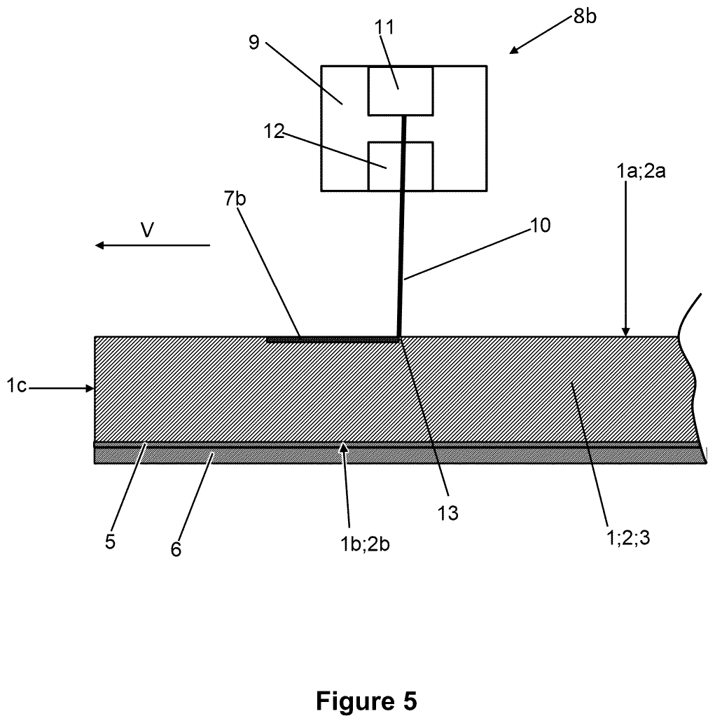

A glass sheet 1 (FIGS. 1, 5) to be marked according to the present disclosure has a first and second glass surface 1a;b and preferably a peripheral glass sheet edge 1c. The glass sheet 1 preferably has only one individual or single glass pane 2 (FIG. 1) in each case. Each glass pane 2 has two glass pane surfaces 2a;b. If the glass sheet 1 has only a single glass pane 2, the two glass pane surfaces 2a;b form the glass surfaces 1a;b of the glass sheet 1.

Particularly preferably, the glass sheet 1 to be marked is a basic glass sheet or glass raw sheet, preferably a float glass sheet 3. As already explained, the production of float glass sheets 3 is carried out by producing an endless float glass ribbon 4, which is cut after cooling to form the float glass sheets 3. The float glass sheets 3 may be separated, in particular cut, from the cooled float glass ribbon 4. The float glass ribbon 4 always comprises a free, cold end 4a.

Preferably, marking of the float glass sheets 3 is now already carried out during production, in that the marking is introduced into the float glass ribbon 4 at the cold end 4a of the float glass ribbon 4 produced before it is cut into float glass sheets 3.

In an analogous manner, the marking can be introduced into the respective basic glass ribbon in other manufacturing processes.

However, the marking of the basic glass sheet, in particular the float glass sheet 3, can also be done after it has been separated from the glass ribbon.

Furthermore, the glass sheet 1 to be marked may also be a glass sheet 1 that has already been further processed, e.g. a single-pane safety glass sheet or a multi-pane insulating glass sheet or a cut-to-size laminated glass sheet, in particular a laminated safety glass sheet (LSG sheet).

A laminated glass sheet is known to consist of several glass panes 2 (not shown) bonded together. Laminated glass sheets are a laminate of at least two individual glass panes 2, which are respectively bonded to one another by means of an adhesive intermediate layer of plastic, in particular by a highly tear-resistant, viscoplastic, thermoplastic film. In this case, the two outer glass pane surfaces 2a;b respectively form the glass surfaces 1a;b of the glass sheet 1. The glass panes 2 of the laminated glass sheet are preferably at least partially pre-stressed glass panes 2. In this case, the marking is applied into the interior of one of the glass panes 2.

As is known, a multi-pane insulating glass sheet consists of at least two glass panes 2, between which there is a cavity that is sealed gas- and moisture-tight.

In addition, the glass sheet 1 or glass pane 2 may have a superficial functional coating 5 on one of its two glass surfaces 1a;b;2a;b.

The functional coating 5 can comprise one or more individual functional layers. If there are several functional layers, it is thus a functional layer laminate. The functional layers change certain properties of the glass sheet 1 or give it certain functions. The functions can be, for example, thermal protection, solar protection, or heating. Preferably, the functional coating 5 is a wavelength-selective coating or low-E coating. The functional coating 5 is not removed prior to the intended use of the glass sheet 1, but is still present during the intended use of the glass sheet 1. The functional coating 5 of the glass sheet 1 generally comprises at least one metal-containing functional layer. Preferably, it respectively is a metal layer or a, preferably ceramic, metal oxide layer. The functional coating 5 of the glass sheet 1 thus comprises at least one metallic and/or at least one, preferably metal-containing, ceramic functional layer. Furthermore, the functional coating 5 preferably has a thickness of <2 μm, preferably <1 μm.

Furthermore, the glass sheet 1 may also comprise on one of its two glass surfaces 1a;b a protective coating 6 known per se in the form of a peelable protective film or a polymer protective layer. This is particularly the case when the glass sheet 1 has a functional coating 5 which has yet to cure and which needs to be protected. The protective coating 6 protects the functional coating 5 arranged underneath.

As already explained, according to a first embodiment of the invention, a laser-induced internal marking 7a is first generated in the glass sheets 1 and this is then also removed again by means of laser radiation. The internal marking 7a is thereby generated by forming color centers (=volume coloring) by means of ultrashort pulsed laser radiation. And the removal or erasure of the internal marking 7a is carried out by means of laser radiation which lies in a wavelength range which is absorbed by the color centers.

FIG. 1 exemplarily shows a marking device 8a for generating the internal marking 7a.

The marking device 8a comprises a laser beam generating device or a laser head 9 for generating or providing a laser beam 10. The laser head 9 can be stationary or movable, for which purpose corresponding drive means are provided.

The laser head 9 comprises a laser radiation source 11 and an associated laser optics 12. By means of the laser optics 12, the laser beam 10 is focused, among other things. In addition, by means of the laser optics 12, the laser beam 10 can be pivoted or deflected from an initial position in which it is aligned vertically or perpendicularly to the glass surface 1a;b, so that it can scan a scan field, which will be discussed in more detail below.

The laser radiation source 11 generates an ultrashort pulsed laser beam 10 with a pulse duration in the picosecond or femtosecond range. Preferably, the laser beam 10 has a pulse duration of 10⁻¹¹ to 10⁻¹³ seconds(s).

In addition, the laser radiation source 11 preferably generates a laser beam 10 whose repetition rate is 10 to several MHz. The higher the repetition rate, the faster the marking can take place. This is particularly important when marking moving glass sheets 1.

Furthermore, the pulse energy is preferably a few micro-Jule to ˜1 mJ.

The laser radiation source 11 also preferably generates a laser beam 10 whose wavelength is from 300 nm to 2 μm, preferably from 533 nm to 1200 nm, particularly preferably from 533 nm to 1 μm.

Preferably, the laser radiation source 11 is thus a VIS laser or an IR laser. Preferably, the laser is also a solid-state laser, preferably a fiber laser.

In addition, the laser radiation source 11 preferably generates a laser beam 10 whose laser power is from 1 to a few 100 W, preferably from 20 to 100 W.

It is known that the generation of color centers by volume coloring depends on the energy density (laser power/area) being set accordingly. If a certain energy threshold is exceeded, material ablation or material melting occurs. How high the energy threshold is depends, among other things, on the material.

The objective of the process according to one aspect of the present disclosure is to produce an internal marking 7a that is as high in contrast and as dark as possible in as short a time as possible.

As already explained, the laser beam 10 is preferably moved by means of the laser optics 12 for the internal marking. For this purpose, the laser optics 12 comprises, in a manner known per se, a scan optics for moving the laser beam 10 in a scan field. Preferably, the scan optics is in the form of at least two adjustable mirrors. The scan field is, for example, 100 mm×100 mm.

Thereby, the internal marking should be carried out as quickly as possible so that it can also be carried out with a glass sheet 1 moving in a feed direction or a glass ribbon 4 moving in a feed direction V. The feed speed of the glass sheet 1 to be marked or of the glass ribbon 4 to be marked is preferably 1 to 80 m/min, preferably 10 to 20 m/min.

The marking can be carried out with a stationary or moving laser head 9. Preferably, the laser head 9 is also moved in the feed direction V during marking, preferably at the same speed as the glass sheet 1 or the glass ribbon 4. The laser head 9 is thus carried along with the glass sheet 1 or the glass ribbon 4. It does not move relative to the glass sheet 1 or the glass ribbon 4 during the marking process. Only the laser beam 10 is moved relative to the glass sheet 1 or the glass ribbon 4 by means of the scan optics within the scan field.

However, the laser optics 12 not only has an influence on the scan field, but also has a direct influence on the result of the marking. The reason for this is that by means of the laser optics 12, the size of the laser focus 13, the depth of focus and thus the energy density in the glass can be adjusted.

Preferably, the laser focus 13 adjusted by means of the laser optics 12 has a diameter of 10 to 100 μm. In addition, the laser focus 13 is between the two glass pane surfaces 2a;b of the glass pane 2 to be marked in order to produce an internal marking 7a that is spaced apart from the glass pane surfaces 2a;b.

The generated internal marking 7a is also preferably a machine-readable code, preferably a data matrix code (DMC) or a barcode or a QR code. However, it may also be a logo, a product ID or a serial number.

The inner marking 7a also preferably comprises the following dimensions:

| | Length | Width |
|---|---|---|
| | 2 to 20 mm | 2 to 20 mm |
| preferably | 2 to 5 mm | 2 to 5 mm |

Preferably, moreover, the internal marking 7a extends, viewed in the glass width direction, over the entire width of the glass sheet 1, i.e. from one glass sheet surface 1a to the other glass sheet surface 1b. It is thus a 3-dimensional internal marking 7a.

Depending on the purpose of the application, it is also preferably a process-specific internal marking 7a, the contents of which directly depict the processing step that has been carried out, and/or an end-customer-specific internal marking 7a.

As already explained, the internal marking 7a typically has a yellow and/or brown color and is recognizable to the human eye. The object is to achieve the darkest possible coloring for the best possible contrast. Reading of the internal marking 7a can be carried out in a manner known per se in white transmitted light. In particular, it is done automatically by means of a reader known per se and adapted to the type of internal marking 7a.

As also explained above, the generation of the internal markings 7a on the basis of color centers is a predominantly reversible process, i.e. the color centers recombine to a greater or lesser extent over time. This so-called recombination occurs spontaneously without external influence.

Within the scope of the present disclosure, it has now been found that the speed of recombination can be selectively increased. Active erasure of the internal marking 7a is known to be possible with a temperature treatment.

According to another aspect of the present disclosure, however, the internal marking 7a can also be erased by targeted, local laser irradiation. It has been found that this is possible in particular with laser radiation having a wavelength that lies in the complementary color range to the color of the internal marking 7a. As a result, the laser radiation is absorbed by the internal marking 7a and the contrast of the internal marking 7a is erased or weakened.

The laser radiation used in the present case to erase or at least weaken the internal marking 7a thus has a wavelength in the violet or blue or green spectral range or in the violet to green spectral range. Preferably, it has a wavelength of 300 to 575 nm.

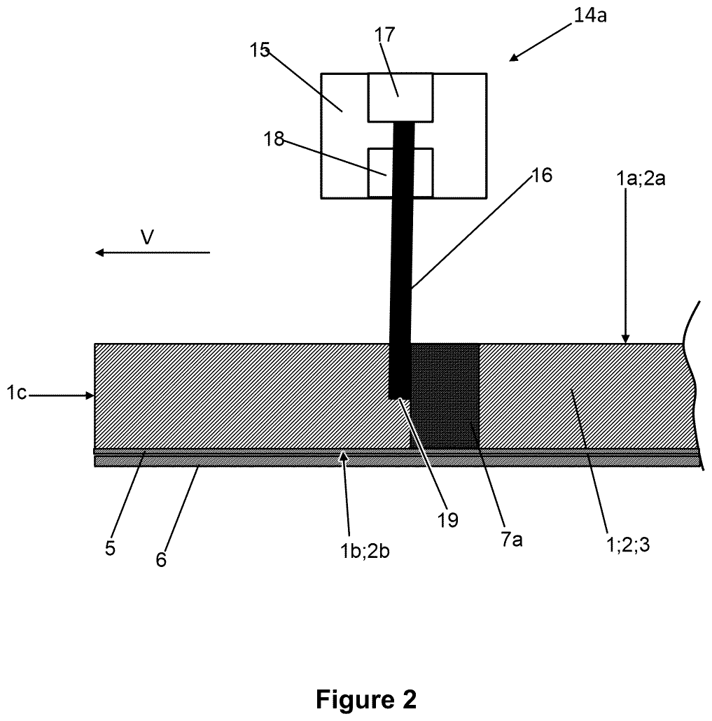

For the erasure of the internal marking 7a, an unmarking device 14a (FIG. 2) is preferably used, which is structurally designed essentially like the marking device 8a.

Consequently, the unmarking device 14a also comprises a laser head or a laser beam generating device 15 for generating a laser beam 16. The laser head 15 can be stationary or movable, for which purpose corresponding drive means are provided.

The laser head 15 has a laser radiation source 17 and an associated laser optics 18. The laser beam 16 is focused by means of the laser optics 18. Thereby, the laser beam 16 can also be pivoted or deflected by means of the laser optics 18 from an initial position in which it is aligned vertically or perpendicularly to the glass surface 1a;b, so that it can scan a scan field, which will be discussed in more detail below.

The laser radiation source 17 thereby generates a pulsed or continuous laser beam 16. In the case of the pulsed laser beam 16, it is preferably a nanosecond laser radiation source. The pulse duration is thus preferably at least 1 ns, preferably several or more ns. However, the pulse duration may also be longer. The pulse duration is thus shorter than in the case of the laser radiation source 11.

Preferably, moreover, the laser radiation source 17 is a solid-state laser, preferably a fiber laser.

Preferably, the laser radiation source 17 generates a laser beam 16 with high energy density to accelerate the erasing process.

The laser beam 16 is preferably moved by moving the laser radiation source 17 together with the laser optics 18. The laser beam 16 is guided, for example, in the form of lines arranged next to each other over the internal marking 7a to be erased. The larger the diameter of the laser focus 19, the wider the lines and the fewer lines are required. The diameter of the laser focus 19 can also be so large that the internal marking 7a only has to be traversed once or not at all, but only has to be illuminated, since the irradiated area is as large as the planar extent of the internal marking 7a.

Of course, the movement of the laser beam 16 can also be performed by means of a scan optics as described above.

Thereby, the unmarking should also take place as quickly as possible so that it can also take place with a glass sheet 1 moving in a feed direction. This can be done in the same way as described above with regard to the marking. However, the unmarking can of course also be carried out on a glass sheet 1 that is not moving. In this case, the laser head 15 is also preferably stationary.

Moreover, according to a first embodiment, analogously to the marking, the laser focus 19 is arranged between the two glass pane surfaces 2a;b of the glass pane 2 to be marked. However, the laser focus 19 can also be located on the glass sheet surface 1a;b or the glass pane surface 2a;b.

Preferably, the laser focus diameter is 50 μm to 500 μm.

The advantage of the method according to the invention is that both the marking and the erasure of the marking can be carried out quickly and inexpensively and without any noticeable change in the mechanical properties of the glass sheets 1. The glass is not changed macroscopically. The glass sheet 1 can thus be marked and unmarked as often as desired without suffering any mechanical damage. The process is thus reversible. In particular, it is also advantageous that the glass sheet 1 is only exposed to laser radiation locally in the area of the internal marking 7a to erase the marking, and the entire glass sheet 1 does not have to be heated. This also significantly reduces the load on the glass sheet 1.

The process according to a yet another embodiment of the present disclosure also offers these advantages. According to the second embodiment of the invention, a superficial surface marking 7b is first produced on the glass sheets 1 by means of laser engraving and this is then removed again by means of laser polishing. The surface marking 7b is a 2-dimensional marking.

In laser engraving, as is known, the glass sheet 1 to be marked is ablated on the glass sheet surface 1a to be marked by means of laser radiation. Within the scope of the invention, it has now been found that it is also possible to remove an engraved surface marking 7b again if it is an ultra-fine engraving. Thereby, the ultra-fine engraving is produced by non-thermal material abrasion from the glass surface 1a by means of ultra-short pulsed laser radiation. In particular, an interaction with the electrons of the network modifiers takes place, which leads to the material abrasion.

Since this is an ultra-fine engraving, it is possible to remove the engraved surface marking 7b again in the first place. This is because the depth of the engraved surface marking 7b is so small that it can be removed by laser polishing.

The engraved surface marking 7b preferably comprises a penetration depth <10 μm, preferably <5 μm, preferably <2 μm.

FIG. 5 exemplarily shows a marking device 8b for generating the superficial surface marking 7b. The marking device 8b is designed analogously to the marking device 8a for generating internal marking 7a, which is why reference is made to the explanations on this, also with regard to the laser parameters.

However, in contrast to the generation of the internal marking 7a, the laser focus 13 is focused on the glass sheet surface 1a to be marked.

Furthermore, the energy density is higher. In particular, it is so high that material abrasion occurs. How high the energy density is depends, among other things, again on the material.

As already explained, the surface marking 7b is erased by laser polishing.

Laser polishing is based on the absorption of laser radiation in a thin superficial layer of the glass sheet 1, so that near-surface temperatures just below the evaporation temperature are achieved. This heating reduces the viscosity of the glass so that the roughness due to surface tension flows out and is smoothed. Thus, smoothing is achieved by remelting, not by material removal. As a result, laser polishing achieves, among other things, an advantageous very low micro-roughness.

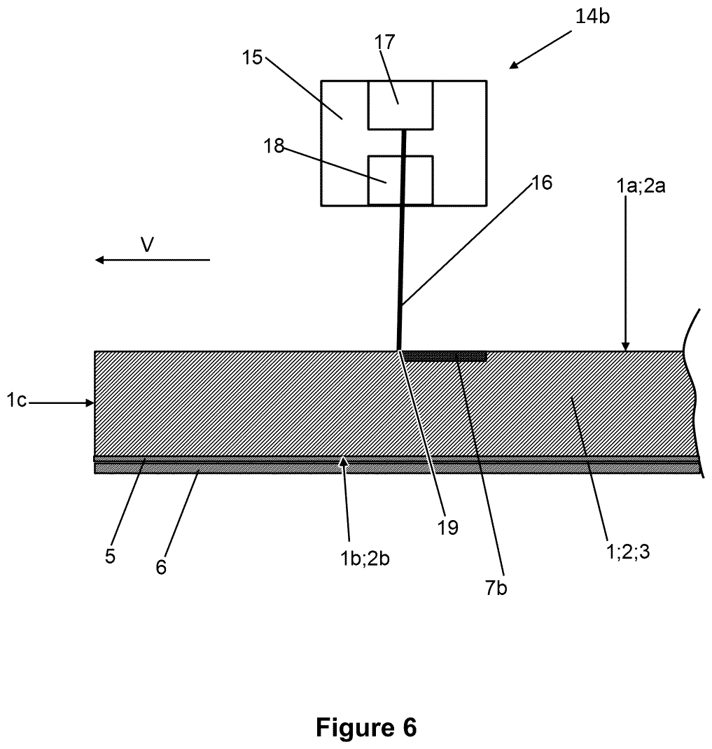

FIG. 6 exemplarily shows an unmarking device 14b for erasing the surface marking 7b. The unmarking device 14b is designed essentially analogously to the marking device 14a for erasing the internal marking 7a, which is why reference is made to the explanations thereon. Preferably, for example, the laser focus diameter is also 50 μm to 500 μm as in the case of erasing the internal marking, so that erasing can also be carried out over a large area.

However, in contrast to erasing the internal marking 7a, the laser focus 19 is always focused on the glass sheet surface 1a.

In addition, the laser radiation source 17 generates laser radiation that is in a wavelength range that is absorbed by the glass sheet surface 1a or glass pane surface 2a.

Preferably, it generates a laser beam 16 whose wavelength is <330 nm or ≥ 4.8 μm.

Preferably, the laser radiation source 17 is a UV laser or an IR laser.

Preferably, the laser radiation source 17 is a CO₂ laser or a CO laser. CO₂ lasers generally generate laser radiation with a wavelength of 10.6 μm. CO lasers generally generate laser radiation with a wavelength of 4.8 to 8.3 μm.

The laser power is preferably from 1 to some 100 W.

The advantage of the second method according to the present disclosure is also that both the surface marking and the erasure of the surface marking 7b can be carried out quickly and inexpensively and without any noticeable change in the mechanical properties of the glass sheets 1. If at all, material abrasion during engraving is minimal and likewise no thermal stresses are generated. Ultra-fine engraving thus also has virtually no effect on the glass strength. The glass sheet 1 can thus be marked and unmarked as often as desired without suffering any mechanical damage. The process is thus reversible. In particular, it is also advantageous that, in order to erase the surface marking 7b, the glass sheet 1 is only subjected to laser radiation locally in the area of the glass sheet surface 1a in the area of the surface marking 7b, and the entire glass sheet 1 does not have to be treated. This also significantly reduces the load on the glass sheet 1.

In addition, the erasure of the internal marking 7a or the surface marking 7b can be easily integrated into the respective manufacturing or processing process. This is particularly true for continuous processes.

For example, at the basic glass manufacturer a marking 7a;b is applied at the end of the manufacturing process and the marked basic glass sheets are then delivered to the glass processor. The latter reads the marking 7a;b and removes it before the next processing step, e.g. cutting or coating with a functional layer, and then applies a new marking 7a;b if desired. This can be done as often as desired. Preferably, there is then no longer any marking 7a;b on the end product.

However, the original marking 7a;b can also be deleted already at the basic glass manufacturer if the latter processes the basic glass sheets further, e.g. already divides them.

As already explained, the single-pane basic glass sheets produced can, for example, also still be provided with a functional coating 5 at the basic glass manufacturer and/or be processed into laminated basic glass sheets by joining two or more single-pane basic glass sheets together. In this case, the original marking 7a;b can be deleted and a new marking 7a;b applied before delivery to the glass processor.

It was found in the course of the invention, however, that it is even possible that the original marking 7a;b does not have to be erased before the application of the functional coating 5 and/or the manufacture of laminated basic glass sheets, since it does not interfere. Surprisingly, the surface marking 7b also does not interfere, since it has such a low penetration depth that it is filled by the film of the laminated basic glass sheet and a functional coating 5 can also be applied to the marked glass sheet surface 1a.

Moreover, any type of glass sheet can be treated by means of the methods according to the invention, for example not only standard float glass but also low-iron float glass. Preferably, however, glass sheets 1 made of silicate glass are marked.

It is also irrelevant whether the marking is irradiated from the tin side or the air side.

The methods according to the present disclosure also ensure a high level of process reliability by adaptively adjusting the contrast to the optics/illumination combination used by the respective reader. As a result, the reading rate can be optimized.

### Exemplary Embodiment 1

Using an IR ps laser (1030 nm), internal markings (DMC's) with an edge length of 5×5 mm and 3×3 mm were generated in an already cut float glass sheet made of silicate glass. The float glass sheet and the laser head were moved relative to each other at a speed of 20 m/min. The laser comprised the following characteristics:

| | | |
|---|---|---|
| Lens focal length | 254 | mm |
| Laser power | 50 | W |
| Repetition rate | 1000 | kHz |
| Scanning speed | 2000 | mm/s |

In each case, internal markings with sufficient contrast were created.

The internal markings were then actively highly weakened or completely erased using laser radiation.

The ns laser (532 nm) used for this purpose comprised the following properties:

| | | |
|---|---|---|
| Laser power | 50 | W |
| Repetition rate | 200 | kHz |
| Scanning speed | 2000 | mm/s |

The markings with medium or low initial contrast were completely erased. Only the darkest markings were still very faintly visible after treatment.

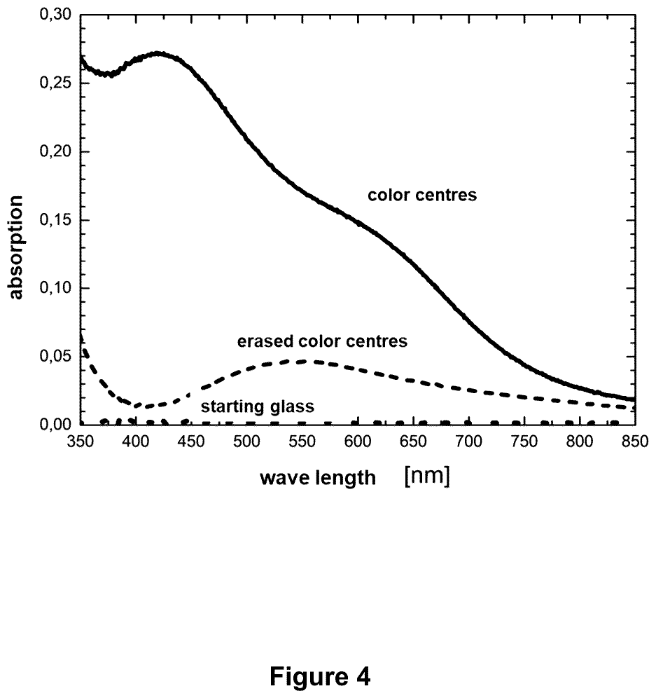

As already described, the markings caused by color centers have a yellow-brown coloration when viewed in white transmitted light. The light is thus absorbed in the blue spectral region. This was also shown by spectroscopic investigations (see FIG. 4). FIG. 4 exemplarily shows a measured absorption spectrum of the color centers of an internal marking with high contrast produced according to the invention, as well as the absorption spectrum of the internal marking after the further laser treatment and the absorption spectrum of the original glass. In the case of the internal marking, a clear absorption band at 425 nm and a somewhat smaller band at about 550-600 nm, here pronounced only as a shoulder, can be seen at the beginning. After laser irradiation, it can be seen that the dominant band at 425 nm has almost completely disappeared, while a residual absorption remained at 550 nm. This is responsible for the still faintly discernible grayish colorations. However, when the irradiation time is increased, this coloration can also be erased.

### Exemplary Embodiment 2

The same laser as for the internal marking was used to generate a surface marking by ultra-fine engraving.

The surface markings were then erased by laser polishing. A continuous CO₂ laser (10.6 μm) with the following properties was used for this purpose:

| | | |
|---|---|---|
| Laser power | 10 | W |
| Scanning speed | 2000 | mm/s |

In the present disclosure, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A method for erasing a laser-induced marking from glass sheets, preferably from basic glass sheets, preferably from float glass sheets, wherein the marking is erased by means of laser radiation.

2. The method according to claim 1, wherein the marking is an internal marking based on color centers.

3. The method according to claim 2, wherein the laser radiation having-used to erase the internal marking has a wavelength which is in a complementary color range to the color centers of the internal marking or lies in a wavelength range which is absorbed by the color centers.

4. (canceled)

5. The method according to claim 2, wherein to erase the internal marking laser radiation is used which comprises:
a) a wavelength in the violet or blue or green spectral range; or
b) from violet to green spectral range; or
c) a wavelength of 300 to 575 nm.

6. (canceled)

7. The method according to claim 1, wherein the marking is a superficial, engraved surface marking on a glass sheet surface of the glass sheet, and the erasure of the surface marking is carried out by means of laser polishing.

8. The method according to claim 7, wherein the laser polishing uses laser radiation which lies in a wavelength range which is absorbed by the glass sheet surface or has a wavelength of <330 nm or ≥4.8 μm.

9. (canceled)

10. The method according to claim 7, wherein a UV laser or an IR laser, preferably a CO₂ laser or a CO laser, is used for the laser polishing.

11. The method according to claim 7, wherein the surface marking has a penetration depth <10 μm, preferably <2 μm.

12. The method according to claim 1, wherein the laser radiation used to erase the marking is continuous laser radiation or laser radiation with a pulse duration of ≥1 ns.

13. The method according to claim 1, wherein the marking is a machine-readable marking, preferably a machine-readable code, especially a data matrix code or a barcode or a QR code.

14. Method A method for marking and unmarking glass sheets, preferably basic glass sheets, especially float glass sheets, the method comprising the following process steps:
a) Laser-induced generation of a marking in the glass sheet or on a surface of the glass sheet-surface,
b) Erasing the marking by means of laser radiation.

15. The method according to claim 14, wherein the process steps are conducted as follows:
a) the laser-induced generation of the marking in the glass sheet comprises forming an internal marking having color centers using ultrashort pulsed laser radiation,
b) the erasing of the internal marking, in the glass sheet includes the use of laser radiation having a wavelength in the violet or blue or green spectral range; or from violet to green spectral range; or a wavelength of 300 to 575 nm.

16. The method according to claim 14, wherein the process steps are conducted as follows:
a) the laser-induced generation of the marking on the surface of the glass sheet comprises laser engraving using ultrashort pulsed laser radiation,
b) the erasing of the marking on the surface comprises laser polishing, that preferably includes the use of laser radiation which lies in a wavelength range which is absorbed by the glass sheet surface or has a wavelength of <330 nm or ≥4.8 μm.

17. The method according to claim 16, wherein the surface marking is generated with a penetration depth of <10 μm, preferably <2 μm.

18. The method according to claim 14, wherein the marking is introduced into an endless basic glass ribbon, preferably a float glass ribbon, during the manufacturing process of the basic glass sheet, preferably the float glass sheet, and the basic glass sheet, preferably the float glass sheet, and is subsequently separated from the endless basic glass ribbon, preferably float glass ribbon.

19. The method according to claim 14, wherein when generating the marking and/or when erasing the marking, a laser head providing the laser radiation is stationary or moved relative to the glass sheet or to a basic glass ribbon; or the glass sheet or the base glass ribbon moves, in particular in a feed direction (V).

20. (canceled)

21. The method according to claim 14, wherein the laser radiation used to generate the marking comprises with a wavelength of 300 nm to 2 μm, preferably of 533 nm to 1200 nm, particularly preferably of 533 nm to 1 μm, and/or a pulse duration of 10⁻¹¹ to 10⁻¹³ seconds.

22. (canceled)

23. The method according to claim 14, wherein the marking is generated using a laser beam having a laser power of 20 to 100 W or a focused laser beam preferably having a diameter of 10 to 100 μm.

24. (canceled)

25. (canceled)

26. The method according to claim 14, wherein the marking generated is a machine-readable marking, preferably a machine-readable code, preferably a data matrix code or a barcode or a QR code.

27. The method according to claim 14, wherein the glass sheets are coated on one surface with a functional coating comprising at least one metal-containing and/or at least one ceramic functional layer, the coated glass sheets being marked and/or unmarked, by irradiating or penetrating the uncoated glass surface with the laser irradiation.

28. A device for marking and unmarking glass sheets, preferably basic glass sheets, especially float glass sheets, preferably by carrying out the method according claim 14, the device comprising:
a) A marking device having a laser head for providing ultrashort pulsed laser radiation for laser-induced generation of an internal marking in the glass sheet by formation of color centers, or of a surface marking by means of laser engraving, preferably with a penetration depth <10 μm; and
b) An unmarking device comprising a laser head for erasing the internal marking by means of laser radiation which preferably lies in a wavelength range which is absorbed by the color centers and/or which preferably has a wavelength which lies in the complementary color range to the color of the internal marking, or for erasing the surface marking by means of laser polishing, preferably with laser radiation which lies in a wavelength range that is absorbed by the surface of the glass sheet.

29. (canceled)

30. The device according to claim 28, wherein the glass sheet or a basic glass ribbon is moved in a feed direction when generating the marking and/or when erasing the marking; or wherein the laser head providing the laser radiation is stationary relative to the glass sheet or to the basic glass ribbon during the generation of the marking and/or during the erasure of the marking, or the device has means for moving the laser head providing the laser radiation relative to the glass sheet or to the basic glass ribbon during the generation of the marking and/or during the erasure of the marking.

31. (canceled)

32. The device according to claim 28, wherein the device has means for moving the laser head when generating the marking and/or when erasing the marking in the feed direction V, preferably at the same speed as the glass sheet or the glass ribbon.

33. The device according to claim 28, wherein the laser head for generating the marking and/or the laser head for erasing the marking respectively has a laser optics with a scan optics for moving the laser beam in a scanning field.

34. (canceled)

35. (canceled)
